(19) United States
(12) Patent Application Publication
(10) Pub. No.: US 2025/0078138 A1
(43) Pub. Date: Mar. 6, 2025

(54) SYSTEM AND METHOD FOR PROVIDING A PRODUCT SOLUTION

(71) Applicant: Belly Technologies LLC, Buda, TX (US)

(72) Inventor: Elie Hakim, Buda, TX (US)

(21) Appl. No.: 18/822,460

(22) Filed: Sep. 2, 2024

Related U.S. Application Data
(60) Provisional application No. 63/580,266, filed on Sep. 1, 2023.

(51) Int. Cl. G06Q 30/0601; G06F 40/30

(52) U.S. Cl. CPC G06Q 30/0631; G06F 40/30

(57) ABSTRACT

A system and method for delivering a product solution through an AI-driven process that dynamically interacts with users to diagnose their needs and refine proposed solutions is provided. The system comprises a user interface, server, database, and an AI engine with sentiment analysis processing, refinement, and recommendation modules. The system iteratively refines solutions based on user feedback and guides users through actionable steps to implement the solution, with the option for post-solution recommendations.

### CROSS-REFERENCE TO RELATED APPLICATION

This application claims the benefit of U.S. Provisional Patent Application No. 63/580,266, filed Sep. 1, 2023, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to systems and methods for recommending a product, and more specifically, to a system and method for providing a product solution through an AI-powered process involving dynamic questioning and interactive dialogue with a user.

### 2. Description of Related Art

This background information is intended to further educate the reader as to additional aspects of the prior art and may present examples of specific aspects of the prior art that is not to be construed as limiting the disclosure of the present application.

In today's rapidly evolving marketplace, consumers and businesses are confronted with an overwhelming array of product and service offerings. The complexity of making informed purchasing decisions has increased as markets have become more fragmented and specialized. This complexity is particularly pronounced in sectors where products and services are interdependent or must work synergistically, such as in technology, healthcare, and business solutions.

Traditionally, individuals and organizations have relied on manual research, consultations with experts, or basic recommendation systems to navigate these choices. These approaches, however, are often inadequate. Manual research is time-consuming and may not yield comprehensive results, as it depends heavily on the user's ability to identify and access relevant information. Consultations with experts can be costly and are often limited by the expert's knowledge or biases. Basic recommendation systems, such as those that rely on static databases or simplistic decision trees, lack the sophistication to fully understand and address the nuanced needs of users, especially in complex scenarios.

Moreover, the traditional approach to problem-solving often involves a disjointed, trial-and-error process where users must engage with multiple providers and solutions, frequently without assurance of compatibility or synergy between the different components. This fragmented landscape imposes significant burdens on users, requiring them to conduct extensive research and engage in time-consuming decision-making processes. Even when users do arrive at a solution, it may not be optimal, and there may be missed opportunities for better integration or enhanced outcomes.

In recent years, artificial intelligence (AI) has emerged as a powerful tool capable of transforming how users interact with complex data and make decisions. AI systems that leverage natural language processing (NLP), machine learning, and dynamic recommendation engines have the potential to address the limitations of traditional methods. Furthermore, while NLP has been used to interpret user inputs, it may not fully capture the user's intent, emotions, or preferences. Sentiment analysis tailored AI, which analyzes the user's emotional state and sentiment, offers a more nuanced understanding of user needs, allowing for more precise and empathetic interactions. Existing systems lack the ability to engage in iterative, personalized dialogue with users, limiting their effectiveness in delivering tailored solutions that meet the specific needs of individuals and organizations.

There is a growing need for a system that can not only understand and diagnose complex problems but also dynamically refine its understanding through interaction with the user. Such a system should be capable of recommending a product solution that considers the compatibility and synergy of various components, ensuring that the final recommendation is both comprehensive and tailored to the user's unique circumstances.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The present invention addresses the challenges outlined above by providing a system and method for delivering product solutions through an AI-driven process. The invention is designed to interact with users in a dynamic, iterative manner, enabling the system to understand and diagnose the specific challenges faced by the user, and to recommend a product solution that is tailored to their unique needs.

At the core is an AI engine that integrates several advanced technologies, including sentiment analysis tailored AI, machine learning, and a dynamic recommendation engine. The system begins by receiving input from the user through a user interface. This input typically describes a problem or challenge that the user is seeking to solve. The AI engine processes this input to gain an initial understanding of the user's needs, while sentiment analysis provides insight into the user's emotional state, helping to refine the interaction and recommendations.

The AI engine comprises multiple sub-modules, each playing a crucial role in refining the problem-solving process. A sentiment analysis processing module interprets the user's input and identifies the core issues that need to be addressed. This module may leverage a machine learning model trained on domain-specific terminology, enabling it to accurately understand and process inputs from various fields or industries.

Once the initial problem is identified, the system engages the user through a refinement engine that uses iterative questioning to gather more detailed information. This interactive dialogue allows the system to clarify the user's requirements, preferences, and constraints, leading to a more precise understanding of the problem.

Based on this refined understanding, the recommendation engine selects a product solution from a product catalog stored in the system's database. The recommendation engine considers factors such as product compatibility, synergy between different components, and the user's specific needs and preferences. The goal is to create a solution that not only addresses the user's problem but also optimizes the overall effectiveness and efficiency of the solution.

A key feature of the invention is its ability to iteratively refine the recommended solution based on ongoing feedback from the user. This ensures that the final solution is highly tailored and aligned with the user's expectations. Once the user is satisfied with the proposed solution, the system guides them through actionable steps to implement the solution, such as making a purchase, scheduling a consultation, or accessing additional resources.

In addition to providing immediate solutions, the system may offer post-solution recommendations. These are designed to complement the selected bundle, further enhancing the value delivered to the user. For example, if the user selects a software package as part of their product solution, the system might recommend additional services such as training or technical support to maximize the utility of the software.

The present invention is particularly well-suited for complex decision-making scenarios where products and services must be combined in a synergistic manner. It offers significant advantages over traditional methods by providing a cohesive, integrated approach to problem-solving that leverages the power of AI to deliver tailored, dynamic solutions.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1A schematic representation of the architecture for a system for providing a product solution, in accordance with an embodiment of the present disclosure; and

FIG. 2 is a flowchart of method for providing a product solution using the system, in accordance with an embodiment of the present disclosure.

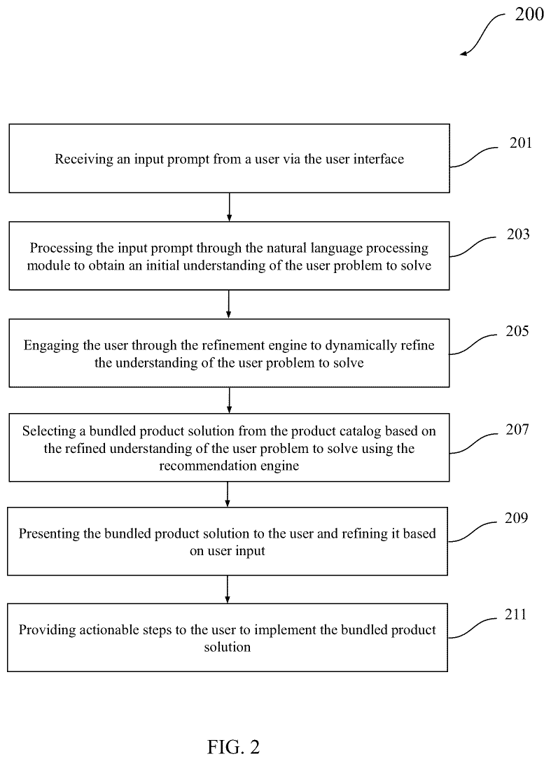

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

While the system and method of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

In the present disclosure, the terms “bundled product” or “bundled product solution” may be used herein to mean one or more product or service offerings provided as a solution to a challenge presented by a user. The terms “bundled product” or “bundled product solution” should not be interpreted to necessitate the inclusion of multiple different products or services whether from a single source or multiple different sources, but may include a single product from a single source, multiple products from a single source, or multiple products from multiple sources, or any combination thereof.

The present invention discloses a system and a method for providing a product solution. The inventive process comprises a sophisticated interplay of AI technologies, interactive dialogue, and intelligent solution aggregation. At the core of the process is an AI engine capable of sentiment analysis processing, machine learning, and adaptive reasoning. This AI engine serves as the conduit for user interaction, utilizing an AI prompt to initiate the problem-solving journey the user experiences.

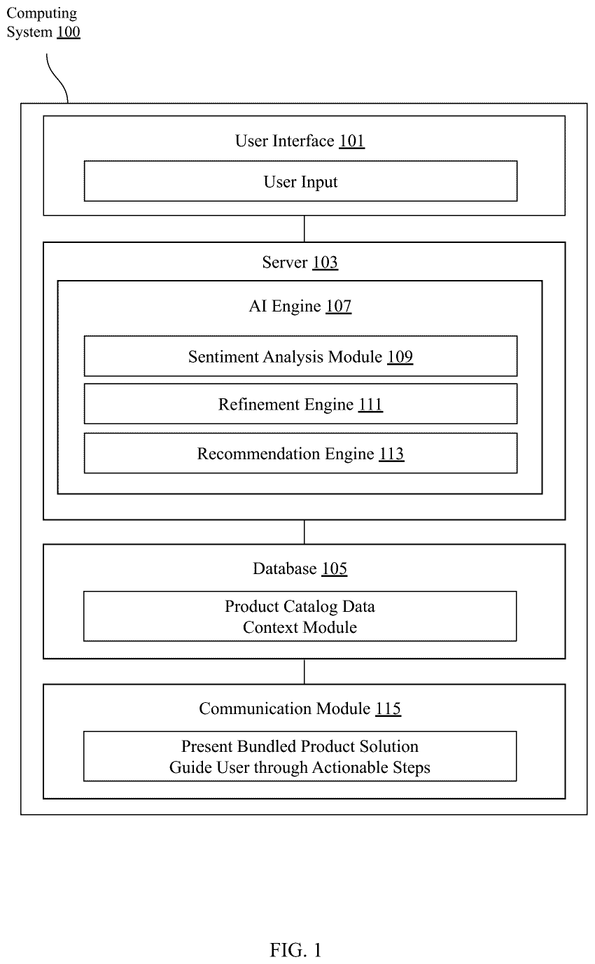

FIG. 1 illustrates an exemplary system and method for providing a product solution, in accordance with an embodiment of the present disclosure. The process commences when a user presents a problem or challenge to the AI system. This input triggers the AI prompt, which engages the user in a series of questions designed to comprehensively unravel the nuances of the problem. Through an iterative process of dynamic branch questioning, the AI system employs advanced sentiment analysis processing techniques through a refinement engine to derive a detailed understanding of the user's circumstances, objectives, and constraints.

The system of FIG. 1 is designed to interact with users in a dynamic and iterative manner to diagnose their needs and recommend product solutions. The system comprises several key components, each of which is described in detail below.

A user interface 101 serves as the primary point of interaction between a user and the system. The user interface 101 is configured to receive an input prompt from the user, which may describe a problem or challenge that the user seeks to solve. The user interface 101 may be implemented as a web-based platform, mobile application, desktop software, or the like. The user interface 101 is designed to be intuitive and user-friendly, allowing users to easily describe their problem or challenge in natural language.

In one embodiment, the user interface 101 is accessible via a client application running on a user device, such as a smartphone, tablet, computer, or the like. The client application communicates with a server 103 over a network, facilitating the exchange of data between the user and the system.

The server 103 is responsible for hosting an AI engine 107 and a database 105, and for managing the flow of data between the system's components. The server 103 may be implemented as a cloud-based platform or as an on-premises solution, depending on the specific requirements of the application. The server 103 processes the input received from the user interface 101 and coordinates the activities of the AI engine 107 and the database 105.

The database 105 stores a comprehensive product catalog that includes a plurality of product offerings and associated data. This data may include product names, descriptions, prices, compatibility information, combinability with other products, and the like. The database 105 is structured to allow for efficient querying and retrieval of data, enabling the AI engine 107 to quickly identify relevant products for inclusion in a product solution.

In addition to storing the product catalog, the database 105 may include a context module that informs a recommendation engine 113 on how to handle initial queries based on predefined contexts. The context module allows the system to tailor its recommendations based on the specific domain or industry in which the user operates.

The AI engine 107 is a core component of the system, responsible for processing the user input and generating the product solution. The AI engine 107 comprises several sub-modules, each of which plays a critical role in the problem-solving process and is described below.

A sentiment analysis module 109 is configured to analyze the emotional tone and sentiment of the user input. This analysis helps the system to not only understand the user's language and context but also to gauge the user's emotional state, preferences, and intent. This information is used to tailor the system's responses and refine the recommendation process. The AI engine leverages this sentiment analysis in conjunction with machine learning algorithms trained on domain-specific terminology relevant to the product offerings in the catalog. By understanding the user's emotional and contextual inputs, the system can make more accurate and empathetic recommendations.

A refinement engine 111 engages the user in an iterative dialogue to further refine the understanding of the problem or challenge. Through dynamic questioning, the refinement engine 111 clarifies the user's requirements, preferences, and constraints. This iterative process allows the system to hone in on the most relevant aspects of the problem, ensuring that the subsequent recommendations are highly tailored to the user's needs.

The refinement engine 111 may be designed to adjust its questioning strategy in real-time based on the user's responses. For example, if the system detects hesitation or uncertainty in the user's input, it may ask follow-up questions or provide additional options to guide the user more effectively.

Additionally, the refinement engine 111 may allow the user to define weighting factors for various criteria, such as cost, compatibility, or reputation of providers. These weights are considered by the recommendation engine when selecting the optimal product solution.

Based on the refined understanding of the problem, a recommendation engine 113 selects a product solution from the product catalog stored in the database 105. The recommendation engine 113 considers factors such as compatibility, synergy, and user preferences when assembling the bundle. The system does not merely suggest individual products but creates a synergistic bundle that collectively addresses the user's problem.

The recommendation engine 113 may be capable of generating multiple alternative product solutions based on different scenarios or constraints provided by the user during the refinement process. This enables the user to evaluate various approaches and select the one that best meets their needs.

Furthermore, the recommendation engine 113 may integrate with third-party platforms to automatically execute actionable steps, such as placing orders or scheduling services, directly from the user interface. Additionally, the system may recommend additional resources such as tutorials, or other instructional content based on the selected product solution to help the user maximize its effectiveness.

Additionally, the recommendation engine 113 is designed to iteratively refine the product solution based on ongoing feedback from the user. This feedback loop ensures that the final solution is optimal and aligned with the user's expectations.

A communication module 115 is responsible for presenting the product solution to the user via the user interface 101. The communication module 115 guides the user through actionable steps to implement the solution, such as initiating a purchase, scheduling a consultation, or accessing further resources. The communication module 115 may also include a post-solution recommendation feature, which suggests additional complementary products or services after the user has selected a product solution. For example, if the user selects a bundle that includes a software product, the system might recommend related training services or support packages to enhance the user's experience.

The communication module 115 may offer an interactive visual representation of the product solution, allowing the user to explore and modify individual components before finalizing the solution. This interactive feature enhances the user experience by providing a clear and customizable view of the recommended products.

The communication module 115 may also integrate with third-party services to facilitate the automatic execution of selected actions, such as ordering products or scheduling services directly through the platform.

It should be appreciated that a key aspect of the invention is the iterative nature of the system's interaction with the user. After presenting the initial product solution, the system remains engaged with the user to gather feedback and make further refinements. This ongoing dialogue ensures that the final solution is highly customized to the user's specific needs and preferences, greatly enhancing the overall user experience.

The system may be designed to store a history of user interactions within the database 105. This historical data may be used by the AI engine 107 to refine future recommendations, taking into account the user's past preferences and behaviors. Additionally, the system may analyze user feedback after the implementation of the product solution, using this information to update the product catalog and improve the accuracy and relevance of future recommendations.

As an example embodiment, consider an entrepreneur who seeks to improve their online marketing efforts. The user inputs a description of their challenge into the user interface 101, which is then processed by the sentiment analysis module 109. Through iterative questioning by the refinement engine 111, the system identifies that the user needs a combination of a website builder, a lead generation tool, and an email marketing service.

The recommendation engine 113 then selects a product solution from the database 105, which includes these three components, ensuring that they are compatible and synergistic. The communication module 115 presents this solution to the user, who can then proceed with purchasing the bundle and implementing it in their business.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A system for providing a product solution, comprising:
a user interface configured to receive an input prompt from a user;
a server in communication with the user interface;
a database storing a product catalog comprising a plurality of product offerings;
an AI engine implemented on the server, the AI engine comprising:
a sentiment analysis processing module configured to interpret the input prompt and identify a user problem to solve;
a refinement engine configured to dynamically interact with the user via the user interface to refine the user problem to solve through the input prompt;
a recommendation engine configured to:
analyze the refined user problem to solve;
select a product solution from the product catalog; and
iteratively refine the product solution based on one or more criteria provided by the user through the input prompt;
a communication module configured to present the product solution to the user via the user interface and guide the user through one or more actionable steps to solve the user problem.

2. The system for providing a product solution of claim 1, wherein the user interface is accessible via a client application running on a user device.

3. The system for providing a product solution of claim 1, wherein the sentiment analysis processing module further includes a machine learning model trained to understand domain-specific terminology relevant to the product offerings in the product catalog.

4. The system for providing a product solution of claim 1, wherein the database further comprises a context module that informs the recommendation engine on handling initial queries based on predefined contexts.

5. The system for providing a product solution of claim 1, wherein the product catalog includes data related to compatibility and combinability of product offerings to facilitate the creation of synergistic product solutions.

6. The system for providing a product solution of claim 1, wherein the communication module further comprises a post-solution recommendation module configured to suggest additional complementary product offerings after the user has selected a product solution.

7. The system for providing a product solution of claim 1, wherein the one or more actionable steps are at least one of making a purchase, scheduling a consultation, and accessing additional resources, or any combination.

8. A method for providing a product solution using the system of claim 1, the method comprising:
receiving an input prompt from a user via the user interface;
processing the input prompt through the sentiment analysis processing module to obtain an initial understanding of the user problem to solve;
engaging the user through the refinement engine to dynamically refine the understanding of the user problem to solve;
selecting a product solution from the product catalog based on the refined understanding of the user problem to solve using the recommendation engine;
presenting the product solution to the user and refining it based on user input;
providing actionable steps to the user to implement the product solution.

9. The method of claim 8, further comprising providing post-solution recommendations based on the selected product solution.

10. The method of claim 8, further comprising the step of storing a history of user interactions in the database, wherein the history is used by the AI engine to refine future recommendations based on past user behavior.

11. The method of claim 8, wherein the refinement engine adjusts its questioning based on real-time analysis of the user's responses.

12. The method of claim 8, further comprising the step of analyzing user feedback after the implementation of the product solution to update the product catalog and improve future recommendations.

13. The method of claim 8, further comprising the step of generating alternative product solutions based on one or more constraints provided by the user during the refinement process.

14. The method of claim 8, wherein the communication module integrates with third-party platforms to automatically execute actionable steps.

15. The method of claim 8, further comprising the step of presenting the user with an interactive visual representation of the product solution.

16. The method of claim 8, wherein the recommendation engine incorporates user-defined weighting factors for different criteria.

17. The method of claim 8, further comprising the step of recommending additional resources to the user based on the selected product solution, to aid in the implementation and usage of the solution.
